(19) United States
(12) Patent Application Publication
(10) Pub. No.: US 2017/0074398 A1
(43) Pub. Date: Mar. 16, 2017

(54) Double-acting piston

(71) Applicant: VIANNEY RABHI, LYON (FR)

(72) Inventor: VIANNEY RABHI, LYON (FR)

(21) Appl. No.: 15/264,051

(22) Filed: Sep. 13, 2016

Related U.S. Application Data
(60) Provisional application No. 62/218,311, filed on Sep. 14, 2015.

(51) Int. Cl. F16J 1/00; F16J 1/12; F16J 1/08

(52) U.S. Cl. CPC F16J 1/005; F16J 1/08; F16J 1/12

(57) ABSTRACT

The double-acting piston (1) includes a lower half-piston (13) and an upper half-piston (14), the periphery of each the half-piston (13, 14) coming into radial stop with a radial traction disc (30) which is tightly held by a clamping screw (29) between the two half-pistons (13, 14) on the one hand, in its center, between a lower central clamping surface (19) and an upper central clamping surface (20) and, on the other hand, at its periphery, between a lower peripheral clamping surface (21) and an upper peripheral clamping surface (22), the clamping by the screw (29) of the disc (30) resulting in prestressing the lower piston cap (15) and the upper piston cap (16) that the lower half-piston (13) and the upper half-piston (14) respectively have.

The present invention relates to a double-acting piston operable at high temperature, consisting of a prestressed assembly.

It would be very interesting, in terms of energy, to manufacture volumetric regenerative engines inspired by Brayton's cycle engines with turbocharger, power turbine, burner and regenerator. The latter engines are the main power source of some gas-fired electricity generating plants or some vessels such as those powered by the “Rolls-Royce WR 21” engine.

We note that the applicant holds two French patent applications relating to a transfer-expansion and regenerative heat engine. The first of these applications was recorded on Jan. 30, 2015 under No. 1,550,762, and the second is dated Feb. 25, 2015 and bears the No. 1,551,593.

Said engine differs from the conventional Brayton regenerative cycle engines in that the commonly used power turbine is replaced by an expander cylinder whose energy efficiency is maximized by intake and exhaust metering valves operating according to a special mode described in the “operation” section of the said applications.

In particular, the phasing of the intake metering valve maximizes the efficiency of the gas expansion by extending the latter to the exhaust pressure. Furthermore, the phasing of the exhaust metering valve is arranged to re-compress the residual exhaust gases trapped in the void volume found at the top dead center of the piston so that before the intake metering valve opens, the pressure and temperature of said gases become equivalent to those of the gases exiting the burner. This latter phasing avoids any irreversibility due to discharge of high pressure gas in a dead volume that remained under low pressure.

According to said applications, the replacement of said power turbine by said expander cylinder is especially enabled by innovative piston sealing means which prevent pressurized gas from leaking between said cylinder and the regulator piston with which it cooperates. The latter two bodies being brought to very high temperature, they exclude any recourse to oil lubrication of either a segment or a ring and any contact between the hot expander cylinder, on the one hand, and a segment or a sealing gasket, on the other hand.

That is why the innovative sealing means proposed in patent applications No. 1,550,762 and No. 1,551,593 allow overcoming any need for lubrication and contact by maintaining an air film sandwiched between a perforated continuous ring and the expander cylinder, the flow of said air further providing cooling of said ring.

Thus, said applications propose an arrangement and novel technical solutions that solve a technical problem so far unresolved, thus meeting the need identified and unmet to enable the production of regenerative engines with a performance substantially higher than that of Brayton turbine regenerative cycle engines, and substantially higher than that of Otto or Diesel internal combustion alternative heat engines of any type.

It should be noted that in applications No. 1,550,762 and No. 1,551,593, the sealing means are included in a secondary claim so as not to exclude the possibility of other sealing means which would provide the same benefits.

This being exposed, whether it is the regulator piston as described in Applications No. 1,550,762 and No. 1,551,593, or any other piston, regulator or not, once said piston operates at high temperatures, it must be made of a material having a sufficiently high mechanical strength at high temperature such as alumina, silicon carbide or zirconium oxide.

Said regulator piston must also remain light to minimize the inertial forces that it generates at high speeds, while being able to withstand high pressure loads to which it may be subjected.

In addition, the fastening means connecting said piston to the transmission means that collect the work produced by said piston are preferably made of high strength steel hardly compatible with the high temperatures to which the regulator piston itself is subjected.

That is why the double-acting piston according to the invention is provided for reciprocating displacement heat engines with cylinder and piston operating at high temperature, and for meeting the triple need for said piston to remain lightweight, resistant, and compatible with steel fastening means that must be kept at low temperature.

In the scope of application of the reciprocating heat machines equipped with piston(s) in general, and heat engines in particular, the invention provides a light, resistant and compatible double-acting piston with fastening means made of high strength steel.

It should be understood that the double-acting piston according to the invention is adaptable to any machine or device equipped with at least one cylinder operating at high temperature. As a non-limiting example, among the examples of application of said invention is the transfer-expansion and regenerative heat engine object of French patent applications No. 1,550,762 and No. 1,551,593, said applications belonging to the applicant.

Other features of the present invention have been described in the specification and in the secondary claims directly or indirectly dependent on the main claim.

The double-acting piston, operable at high temperature and cooperating with transmission means to move in a cylinder whose end, which opens on the side of said means, is closed by a lower cylinder head to define with said piston a lower hot gas chamber, and whose other end is closed by an upper cylinder head to define with said piston an upper hot gas chamber, the transmission means being housed within a transmission housing to which the cylinder is fixed directly or indirectly, comprises according to the invention:
A lower half-piston having a lower piston cap facing the lower hot gas chamber, said cap prolonged by a lower piston rod which passes through the lower cylinder head via a lower rod hole formed in said cylinder head, said rod being directly or indirectly secured to transmission means, while the face of said half-piston opposite said cap is hollow and forms a relief lower recess;
A lower central pillar, coaxial with the lower half-piston, which is housed in the lower relief recess and ends in a lower central clamping surface;
At least one lower peripheral clamping surface provided on the lower half-piston and which borders lower relief recess at the periphery of said half-piston;
At least one lower radial limit stop arranged in the lower half-piston near the lower peripheral clamping surface;
A lower clamping screw bore arranged in the lower half-piston at its center, and which passes through said half-piston from side to side in the axial direction;
An upper half-piston which presents an upper piston cap facing the upper hot gas chamber, said cap being prolonged or not by an upper piston rod which penetrates or passes through the upper cylinder head via an upper rod hole arranged in said cylinder head, while the face of said half-piston opposite said cap is hollow and forms an upper relief recess;
An upper central pillar, coaxial with the upper half-piston, which is housed in the upper relief recess to end in an upper central clamping surface;
At least one upper peripheral clamping surface arranged on the upper half-piston and which borders the upper relief recess at the periphery of said half-piston;
At least one upper radial stop arranged in the upper half-piston near the upper peripheral clamping surface;
An upper clamping screw bore arranged in the upper half-piston at its center, and which passes through said half-piston from side to side in the axial direction;
At least one radial traction disc, perforated or not, pierced at its center with a screw through-hole whose outer diameter is close to that of the double-acting piston, whose central zone is tightly mounted between the lower central clamping surface and the upper central clamping surface, whose peripheral zone is tightly mounted between the lower central clamping surface and the upper central clamping surface, and whose periphery comprises at least one traction radial stop which can cooperate with the lower radial stop and/or the upper radial stop;
A clamping screw housed partly in the lower clamping screw bore and partly in the upper clamping screw bore, the first end of said screw being made integral with the transmission means while the second end of said screw is made integral with the upper piston rod or of the upper cap of the piston.

The double-acting piston according to the present invention comprises a thickness and a geometry of the radial traction disc as well as an axial position of the lower central clamping surface, of the upper central clamping surface, of the lower peripheral clamping surface, and of the upper peripheral clamping surface which are designed so that, when the clamping screw is tightened while mounting the double-acting piston, said disc is first compressed between the lower peripheral clamping surface and the upper peripheral clamping surface before being compressed between the lower central clamping surface and the upper central clamping surface.

The double-acting piston according to the present invention comprises a radial position of the traction radial stop relative to the lower radial limit stop and/or the upper radial limit stop which is provided so that, when the clamping screw is tightened at mounting the double-acting piston, said lower and/or upper radial limit stop comes into contact with the traction radial stop and limits the diameter of the lower half-piston and/or the upper half-piston.

The double-acting piston according to the present invention comprises a radial traction disc having in its periphery a ring groove which can accommodate sealing means.

The double-acting piston according to the present invention comprises a ring groove which is housed in a groove of groove that is commonly constituted by a lower overhang included at the periphery of the lower half-piston, and an upper overhang included at the periphery of the upper half-piston.

The double-acting piston according to the present invention comprises at least one air supply radial duct which is arranged in the thickness of the radial traction disc, said duct connecting the screw through-hole to the periphery of said disc.

The double-acting piston according to the present invention comprises a radial traction disc which consists of two radial traction half-discs on the surface of at least one of which is arranged at least one radial duct groove which constitutes the air supply radial duct when said two half-discs are pressed against each other as a result of the tightening of the clamping screw.

The double-acting piston according to the present invention comprises an end of the upper piston rod which is furthest from the upper piston cap which is always immersed in a pressure chamber filled with compressed air regardless of the position of the double-acting piston in the cylinder, said chamber being integral or not to the upper cylinder head and being connected to a pressurized air source from which the compressed air originates, while said end has at least one air supply channel that connects the upper clamp screw shaft with the pressure chamber.

The double-acting piston according to the present invention comprises an air supply channel which consists of a radial groove arranged either on the flat end of the upper piston rod which is furthest from the piston upper cap, or on at least one of the faces of a screw thrust washer on which the clamping screw rests.

The double-acting piston according to the present invention comprises a screw cooling tube which surrounds the clamping screw on all or part of its length, compressed air coming from the pressurized air source being able to flow into a space left between the inner wall of said tube and the outer surface of the clamping screw, while the greatest possible portion of the outer surface of said tube does not touch the internal wall of the upper clamping screw bore so as to define a vacuum space with the latter wall.

The double-acting piston according to the present invention comprises a screw cooling tube having a tube flange held clamped by the clamping screw against the end of the upper piston rod.

The double-acting piston according to the present invention comprises a screw cooling tube which comprises at least one tube bulge consisting of an axial portion of said tube whose diameter is substantially equivalent to, or slightly greater than that of the upper clamping screw bore or the lower clamping screw bore in which it is housed.

The double-acting piston according to the present invention comprises a screw cooling tube which includes at least one tube diameter restriction consisting of an axial portion of said tube whose diameter is substantially equivalent to, or slightly smaller than that of the body of the clamping screw.

The double-acting piston according to the present invention comprises a screw cooling tube which has at least one radial communication hole which allows the compressed air to penetrate into said tube, or to escape from it.

The double-acting piston according to the present invention comprises a lower rod orifice and/or upper rod orifice which cooperate with—or which comprise—rod sealing means which create a seal between the lower piston rod and the lower cylinder head and/or between the upper piston rod and the upper cylinder head.

The double-acting piston according to the present invention includes rod sealing means which comprise an upper rod seal and a lower rod seal sufficiently distant from each other to form—between said two seals—a chamber for circulating oil into which leads a duct for supplying cooling-lubrication oil, and out of which leads an outlet duct of cooling-lubricating oil.

The double-acting piston according to the present invention includes rod sealing means rod which cooperate with a rod guiding ring housed inside or outside the oil flow chamber.

The description that follows in addition to the drawings, annexed and given by way of non-limiting examples, will allow a better understanding of the invention, its characteristics, and the advantages that it can likely provide:

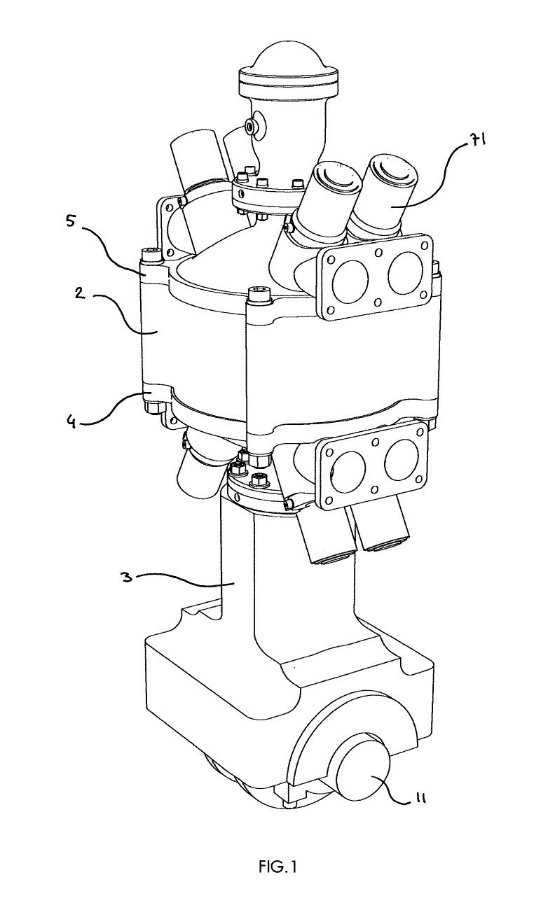

FIG. 1 is a three-quarter tridimensional view of a cylinder set, lower cylinder head and upper cylinder secured to a transmission case which receives the double-acting piston according to the invention.

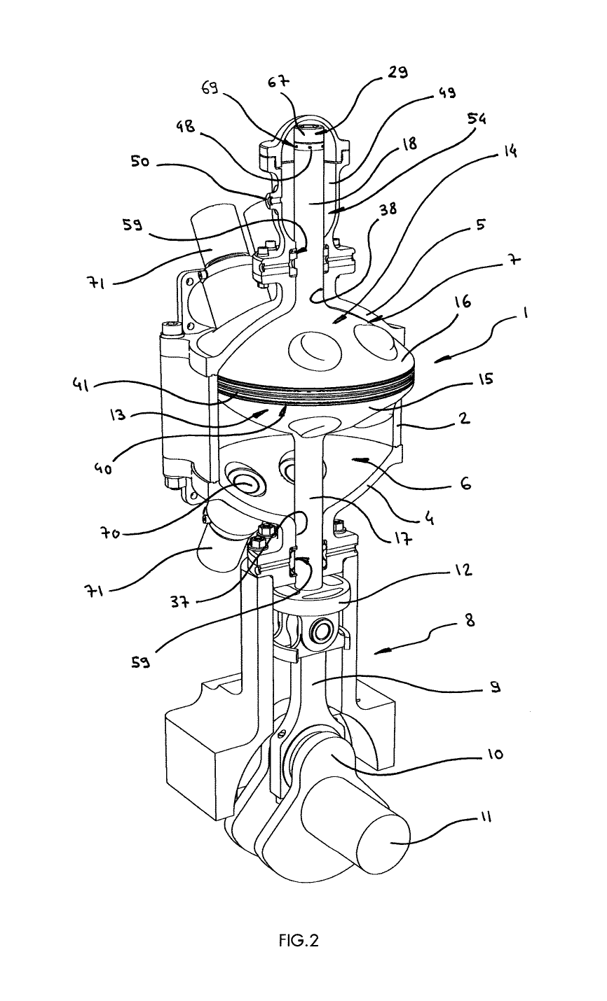

FIG. 2 is a tridimensional front and cross-sectional view of the double-acting piston according to the invention, the latter being housed in the cylinder with which it cooperates, said view also showing the transmission case that houses the transmission means provided to collect the work produced by said piston, said means consisting, according to this embodiment, of a connecting rod hinged on a crank connected to a crankshaft, and of a butt.

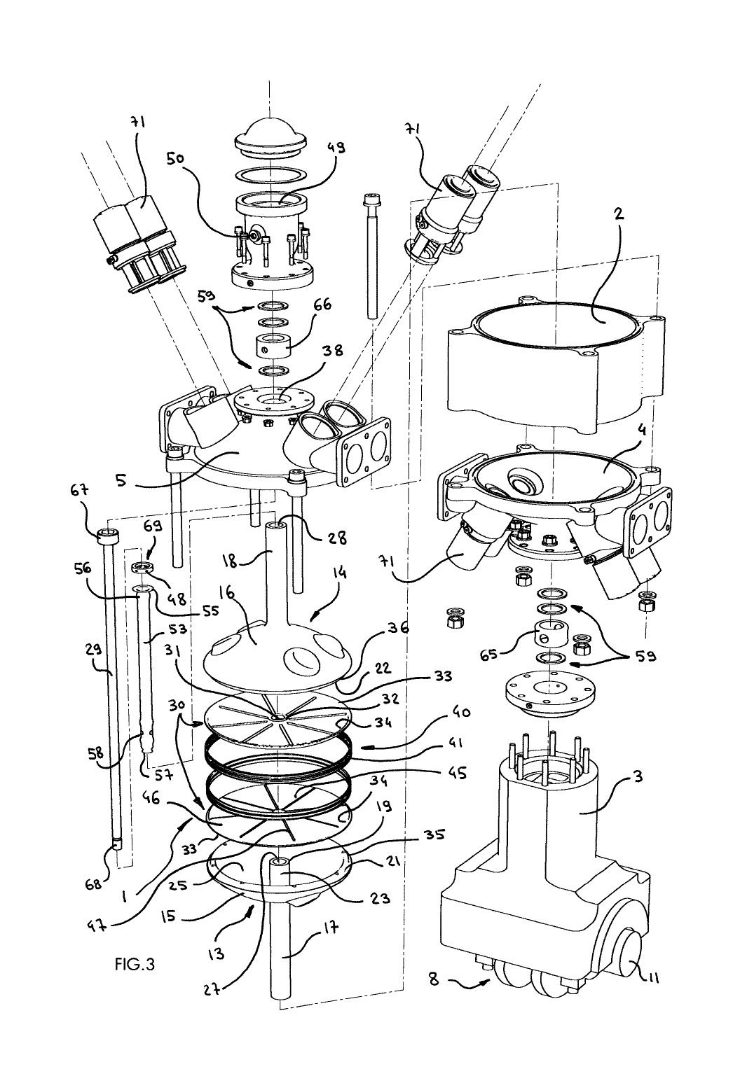

FIG. 3 is an exploded tridimensional view of the double-acting piston according to the invention, and the different organs with which it cooperates.

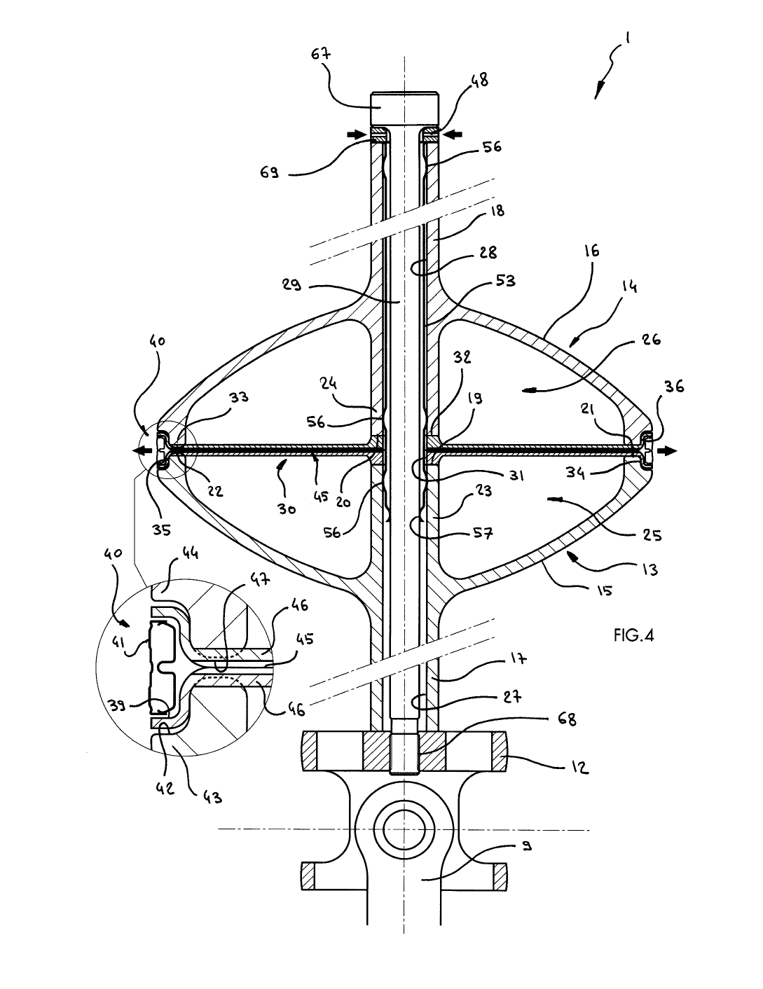

FIG. 4 is a schematic longitudinal section of the double-acting piston according to the invention with an inset close-up view showing the detail of groove of the groove which—according to a particular example of embodiment—houses the ring groove in which is housed a perforated continuous ring.

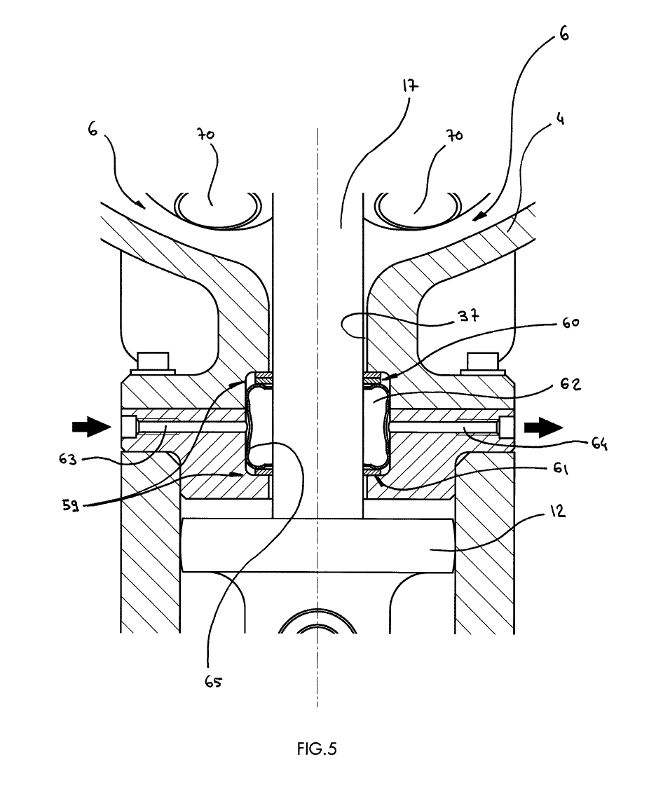

FIG. 5 is a schematic sectional view including rod sealing means which cooperate with the lower piston rod of the double-acting piston according to the invention.

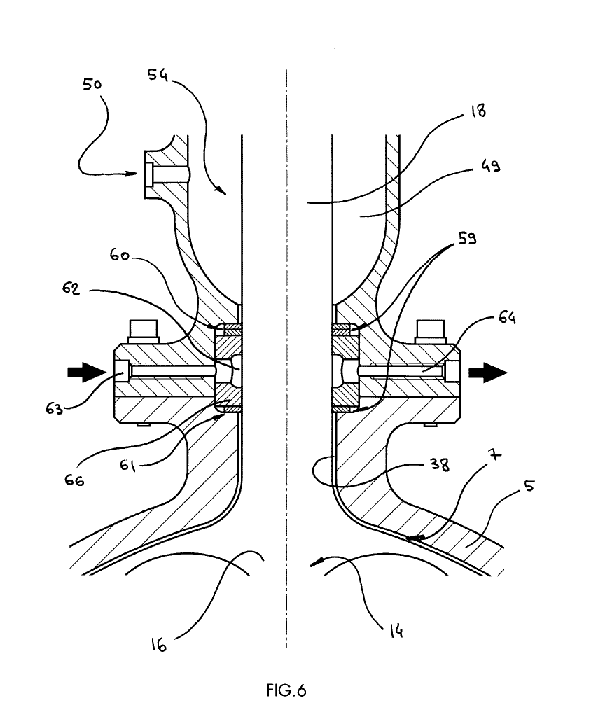

FIG. 6 is a schematic sectional view including rod sealing means which cooperate with the upper piston rod of the double-acting piston according to the invention, said upper rod leading—according to this particular example of embodiment—into a pressure chamber.

### DESCRIPTION OF THE INVENTION

FIGS. 1 to 6 showed the double-acting piston 1, various details of its components, its variants, and its accessories.

As shown in FIG. 2, the double-acting piston 1 according to the invention, which can operate at high temperature, cooperates with transmission means 8 to move in a cylinder 2 whose end, which leads into the side of said means 8, is closed by a lower cylinder head 4 to define with said piston 1 a lower hot gas chamber 6, and whose other end is closed by an upper cylinder head 5 to define with said piston 1 an upper hot gas chamber 7, the transmission means 8 being housed in a transmission case 3 on which is fixed, directly or indirectly, the cylinder 2.

In this same FIG. 2, we can see that the transmission means 8 may in particular consist of a rod 9 hinged around a crank 10 arranged on a crankshaft 11, said rod 9 being connected to the double-acting piston 1 through a butt 12.

By way of non-represented variant, the transmission means 8 may consist of a cam, a transmitting hydraulic pump, a power generator or any other known transmission means to those skilled in the art.

It should also be noted—as shown in particular in FIGS. 1 to 3—that the lower cylinder head 4 and the upper cylinder head 5 may comprise at least one valve 70 controlled by a valve actuator 71.

FIG. 4 illustrates in particular that the double-acting piston 1 according to the invention comprises a lower half-piston 13 which has a lower piston cap 15 facing opposite to the lower hot gas chamber 6, said cap 15 being prolonged by a lower piston rod 17 which passes through the lower cylinder head 4 through a lower rod orifice 37 provided in said cylinder head 4, said rod 17 being directly or indirectly secured to the transmission means 8, while the face of said half-piston 13 opposite said cap 15 is hollow and constitutes a lower relief recess 25.

It should be noted that the lower relief recess 25 may be compartmentalized and/or reinforced with ribs. Furthermore, the lower piston cap 15 and the lower piston rod 17 may be made in a single piece of a material which maintains high mechanical strength at high temperature such as alumina, silicon carbide or zirconium oxide.

FIGS. 3 and 4 show that the double-acting piston 1 according to the invention comprises a lower central pillar 23, coaxial with the lower half-piston 13, which is housed in the lower relief recess 25 and ends in a lower central clamping surface 19.

It should be noted that, advantageously, the lower central pillar 23 may be made from the same piece of material as the lower half-piston 13, or be attached to it.

FIGS. 3 and 4 illustrate that the double-acting piston 1 according to the invention comprises at least one lower peripheral clamping surface 21 formed on the lower half-piston 13 which borders the lower relief recess 25 at the periphery of said half-piston 13, said surface 21 being minimal in order to let penetrate the least amount of heat possible.

The double-acting piston 1 according to the invention also comprises at least one lower radial limit stop 35 fitted in the lower half-piston 13 near the lower peripheral clamping surface 21.

In addition, as shown in FIGS. 3 and 4, the double-acting piston 1 according to the invention comprises a lower clamping screw bore 27 arranged in the lower half-piston 13 at its center, and which passes through said half-piston 13 from one side to the other in the axial direction.

It can be seen in FIGS. 3 and 4 that the double-acting piston 1 according to the invention comprises an upper half-piston 14 having an upper piston cap 16 facing opposite the upper hot gas chamber 7, said cap 16 being prolonged or not by an upper piston rod 18 that penetrates or passes through the upper cylinder head 5 through an upper rod orifice 38 formed in said cylinder head 5, while—as particularly shown in FIG. 4—the face of said half-piston 14 opposite said cap 16 is hollow and forms an upper relief recess 26 compartmentalized or not, and/or reinforced with ribs or not, the upper piston cap 16 and the upper piston rod 18 being preferably made of a single piece of a material which maintains high mechanical strength at high temperature such as alumina, silicon carbide or zirconium oxide.

It can be seen in FIG. 4 that the double-acting piston 1 according to the invention comprises an upper central pillar 24, said pillar 24 being coaxial to the upper half-piston 14, while said pillar 24 is accommodated in the upper relief recess 26 to end in an upper central clamping surface 20, said pillar 24 being optionally made from the same piece of material as the lower half-piston 14, or be attached to it.

FIGS. 3 and 4 illustrate that the double-acting piston 1 according to the invention has at least an upper peripheral clamping surface 22 provided on the upper half-piston 14 which borders the upper relief recess 26 at the periphery of said half-piston 14, said surface 21 being minimal in order to let penetrate the least amount of heat possible.

FIGS. 3 and 4 show that the double-acting piston 1 according to the invention comprises at least one upper radial limit stop 36 arranged in the upper half-piston 14 near the upper peripheral clamping surface 22.

Moreover, the double-acting piston 1 according to the invention also comprises an upper clamping screw bore 28 arranged in the upper half-piston 14 at its center, and which passes through said half-piston 14 from one side to the other in an axial direction. Said shaft 28 is particularly visible in FIGS. 3 and 4.

Still in FIGS. 3 and 4, it can be seen that the double-acting piston 1 according to the invention comprises at least one radial traction disc 30, perforated or not, pierced at its center with a screw through-hole 31, whose outer diameter is close to that of the double-acting piston 1, whose central zone 32 is tightly mounted between the lower central clamping surface 19 and the upper central clamping surface 20, whose peripheral zone 33 is tightly mounted between the lower peripheral clamping surface 21 and the upper peripheral clamping surface 22, and whose periphery comprises at least one radial traction stop 34 that can cooperate with the lower radial limit stop 35 and/or the upper radial limit stop 36 so to limit the outer diameter of the lower half-piston 13 and/or the upper half-piston 14.

Finally, FIGS. 3 and 4 show that the double-acting piston 1 according to the invention comprises a clamping screw 29 housed partly in the lower clamping screw bore 27 and partly in the upper clamping screw bore 28, the first end of said screw 29 being made integral with the transmission means 8 while the second end of said screw 29 is made integral with the upper piston rod 18 or the upper piston cap 16 in case the latter is not prolonged by an upper piston rod 18.

It should be noted that said ends may be made integral one with the transmission means 8 and the other with the upper piston rod 18 or the upper piston cap 16 by means of a clamping screw head 67, or a screw thread 68 that is included in the clamping screw 29, said thread 68 being screwed into a nut or a bore.

It should be further noted that the clamping of the clamping screw 29 results in tightening the radial traction disc 30 between the lower central clamping surface 19 and the upper central clamping surface 20, on the one hand, and between the lower peripheral clamping surface 21 and the upper peripheral clamping surface 22, on the other hand.

It should be noted that if the upper piston cap 16 is not prolonged by an upper piston rod 18, the head or the nut which terminates the clamping screw 29 and which holds said cap 16 tight may be housed in a cavity formed therein, said cavity being optionally closed by a plug.

In any case, the clamping screw 29 does not exclude the possibility of providing one or more other screws that together connect the lower piston cap 15 and the upper piston cap 16.

It should be ruled out either that the shape and/or curvature of the lower piston cap 15 be different from that of the upper piston cap 16, said caps 15, 16 also optionally comprising recesses or protuberances facing valves or dampers that the lower cylinder head 4 and/or the upper cylinder head 5 may respectively comprise.

It should be noted that according to a particular embodiment of the double-acting piston 1 according to the invention, the thickness and geometry of the radial traction disc 30 as well as the axial position of the lower central clamping surface 19, of the upper central clamping surface 20, of the lower peripheral clamping surface 21, and the upper peripheral clamping surface 22 may be provided so that, when the clamping screw 29 is tightened while mounting the double-acting piston 1, said disc 30 is first compressed between the lower peripheral clamping surface 21 and the upper peripheral clamping surface 22 before being compressed between the lower central clamping surface 19 and the upper central clamping surface 20.

It follows from this arrangement that the lower piston cap 15 and the upper piston cap 16 are placed under prestress which ensures the clamping of the radial traction disc 30 when the double-acting piston 1 is deformed under the effect of the pressure prevailing in the lower hot gas chamber 6 or in the upper hot gas chamber 7.

Still according to a particular embodiment of the double-acting piston 1 according to the invention, the radial position of the radial traction stop 34 relative to that of the lower radial limit stop 35 and/or the upper radial limit stop 36 may be provided so that when the clamping screw 29 is tightened while mounting the double-acting piston 1, said lower radial limit stop 35 and/or upper 36 comes into contact with the radial traction stop 34 and limits the diameter of the lower half-piston 13 and/or the upper half-piston 14.

It follows from this arrangement that the lower piston cap 15 and the upper piston cap 16 each creates two arches which oppose a high mechanical resistance to the forces produced by the pressure in the lower hot gas chamber 6 and/or in the upper hot gas chamber 7. The first baseplate of the arches that is constituted by the lower piston cap 15 is secured at the lower central pillar 23 while the second baseplate of said arches is secured at the lower radial lower limit stop 35. The same is true for the upper piston cap 16 which forms two arches whose baseplates are respectively secured at the upper central pillar 24 and at the upper radial limit stop 36.

FIGS. 3 and 4 show that according to the double-acting piston 1 of the invention, the radial traction disc 30 may have in its periphery a ring groove 39 which can accommodate sealing means 40 such as a perforated continuous ring 41 with air cushion similar or identical to that described in the French patent applications No. 1,550,762 and No. 1,551,593 belonging to the applicant and allowing the production of a transfer-expansion and regenerative heat engine.

FIG. 4 allows visually clarifying that the ring groove 39 may be housed in a groove of groove 42 that is commonly formed by a lower overhang 43 that the lower half-piston 13 comprises in its periphery, and an upper overhang 44 that the upper half-piston 14 comprises in its periphery.

According to this particular configuration, a heat insulating space may advantageously be left between the radial traction disc 30 at the ring groove 39 and the groove of groove 42, said space constituting a thermal barrier.

It is noted in FIG. 4 that the double-acting piston 1 according to the invention may comprise at least one air supply radial duct 45 arranged in the thickness of the radial traction disc 30, said duct 45 connecting the screw through-hole 31 to the periphery of said disc 30 so as, for example, to supply compressed air 54 to a perforated continuous ring 41 with air cushion similar or identical to that described in the French patent applications No. 1,550,762 and No. 1,551,593 belonging to the applicant and allowing the production of a transfer-expansion and regenerative heat engine.

It should also be noted that the cavities formed by the lower relief recess 25 and the upper relief recess 26 may be pressurized by the compressed air 54 that feeds the perforated continuous ring 41 or that feeds any other sealing means 40 requiring said compressed air 54.

It should be noted in FIGS. 3 and 4 that according to the double-acting piston 1 of the invention, the radial traction disc 30 may be constituted by two radial traction half-discs 46 to the surface of at least one of which is fitted at least one radial duct groove 47 which forms the air supply radial duct 45 when said two half-discs 46 are pressed against each other as a result of the clamping of the clamping screw 29.

FIGS. 2, 3 and 6 show that according to a variant embodiment of the double-acting piston 1 according to the invention, the end of the upper piston rod 18 which is furthest from the upper piston cap 16 may remain always immersed in a pressure chamber 49 filled with compressed air 54 whatever the position of the double-acting piston 1 in the cylinder 2.

It should be noted that said chamber 49 may be integral or not with the upper cylinder head 5 and be connected to a pressurized air source 50 from which compressed air 54 is supplied, while the end of the upper piston rod 18 has at least one air supply channel 48 which connects the upper clamping screw bore 28 to the pressure chamber 49 so as, for example, to cooperate in the supply of compressed air 54 to a perforated continuous ring 41 with air cushion, similar or identical to that described in the French patent applications No. 1,550,762 and No. 1,551,593 belonging to the applicant, and allowing the production of a transfer-expansion and regenerative heat engine.

Alternatively, the pressure chamber 49 may be connected to the lower clamping screw bore 27, an air supply channel connecting said well 27 to said chamber 49. In this case, the chamber 49 may be formed, for example, by the volume swept by a butt 12, which is sealed so as to be connected to the pressurized air source 50.

It should be noted that—irrespective of the selected configuration—the pressurized air source 50 may include an air compressor which forces the compressed air 54 to flow into the upper clamping screw bore 28 or the lower clamping screw bore 27, said compressor being able to continue running for some time after stopping the heat machine to which is applied the double-acting piston 1 according to the invention. This last configuration all, for example, removing the heat that said piston 1 is likely to continue transmitting during cooling to the clamping screw 29.

It may be specified here that the air supply channel 48 may optionally be composed of at least one radial groove arranged either on the flat end of the upper piston rod 18 which is furthest from the upper piston cap 16, or on at least one of the faces of a screw thrust washer on which rests the clamping screw 29.

As shown in FIGS. 3 and 4, the double-acting piston 1 according to the invention may comprise a screw cooling tube 53 which surrounds the clamping screw 29 on all or part of its length, compressed air 54 from the pressurized air source 50 being able to flow into a space left between the inner wall of said tube 53 and the outer surface of the clamping screw 29, provided that the greatest possible portion of the outer surface of said tube 23 does not touch the inner wall of the upper clamping screw bore 28 so as to define a vacuum space with the latter wall.

It should be noted that according to the chosen embodiment of the double-acting piston 1 according to the invention, the screw cooling tube 53 may descend to the level of the lower clamping screw bore 27.

As can be seen in FIGS. 3 and 4, the screw cooling tube 53 may comprise a tube flange 55 held clamped by the clamping screw 29 against the end of the upper piston rod 18.

In addition, the screw cooling tube 53 may also include at least one tube bulge 56 consisting of an axial portion of said tube 53 whose diameter is substantially equivalent to or slightly larger than that of the upper clamping screw bore 28 or the lower clamping screw bore 27 in which it is housed, this ensuring that said tube 53 remains locally centered in said shaft 28 or 27, and, if necessary, forming a seal between said tube 53 and said shaft 28 or 27.

It should also be noted in FIGS. 3 and 4 that the screw cooling tube 53 may possibly comprise at least one tube diameter restriction 57 consisting of an axial portion of said tube 53 whose diameter is substantially equivalent, or slightly smaller than that of the body of the clamping screw 29 in order to locally form a seal between said tube 53 and said screw 29.

In FIG. 58, it is noted that the screw cooling tube 53 may comprise at least one radial communication hole 58 which allows compressed air 54 into said tube 53, or to escape from it.

It should be noted in FIGS. 2, 3, 5 and 6 that according to a particular embodiment of the double-acting piston 1 of the invention, the lower rod orifice 37 and/or the upper rod orifice 38 may cooperate with—or may comprise—rod sealing means 59 that form a seal between the lower piston rod 17 and the lower cylinder head 4 and/or between the upper piston rod 18 and the upper cylinder head 5.

Specifically, FIGS. 5 and 6 show that the rod sealing means 59 may comprise an upper rod seal 60 and a lower rod seal 61 sufficiently distant from each other to form—between said two seals 60, 61—an oil flow chamber 62 into which a cooling-lubricating oil supply duct 63 enters, and out of which a cooling-lubricating oil outlet duct 64 goes.

It should be noted that the oil flow chamber 62 performs the double function of lubricating and cooling the lower piston rod 17 and/or the upper piston rod 18. It is further noted that the upper rod seal 60 and/or the lower rod seal 61 may be composed in particular of a cutting segment or two superposed cutting segments and whose sections are angularly offset while the outer surface of the lower piston rod 17 and/or upper piston rod 18 may be provided with double helix shallow cuts which form a succession of oil reservoirs and hydrodynamic lift surfaces.

It is noted in FIG. 5 that the one or more segment(s) which form the upper rod seal 60 may be kept separate from those forming the lower rod seal 61 by a segment retractor spring 65 also designed—in particular because it comprises holes or passages—to let through the cooling and lubrication oil flow established between the cooling-lubricating oil supply duct 63 and the cooling-lubricating oil outlet duct 64.

Also, according to a particular embodiment of the double-acting piston 1 of the invention, all or part of the space left between the clamping screw 29 and the inner wall of the lower clamping screw bore 27 and/or the upper clamping screw bore 28 may be filled with sodium, lithium salts or potassium salts to indirectly promote cooling of the lower piston rod 17 and/or the upper piston rod 18 by the oil flow chamber 62.

As illustrated in FIG. 6, the rod sealing means 59 may cooperate with a rod guiding ring 66 housed inside or outside the oil flow chamber 62, said ring 66 being made of bronze or other material commonly used for making anti-friction and/or hydrodynamic bearings or rings.

Said ring 66 can provide radial guidance of the lower piston rod 17 in the lower cylinder head 4 and/or the upper piston rod 18 in the upper cylinder head 5.

It should be noted, moreover, that if—as illustrated in FIGS. 2, 4 and 5—the transmission means 8 comprise a butt 12, the rod sealing means 59 are preferably provided with a guiding ring 66 rod when applied to the upper piston rod 18, while the radial guidance of the lower piston rod 17 is ensured by said butt 12 alone.

### OPERATING MODE OF THE INVENTION

The operation of the double-acting piston 1 according to the invention is easily understood when observing FIGS. 1 to 6.

To detail the said operation, we will assume here that said double-acting piston 1 is applied to the transfer-expansion and regenerative heat engine for which the French patent applications No. 1,550,762 and No. 1,551,593 are owned by the applicant. This application only serves as an example and does not exclude any other use of the double-acting piston 1 of the invention.

As particularly apparent in FIGS. 2 and 3, the double-acting piston 1 can move in the cylinder 2 which is closed by its lower cylinder head 4 and its upper cylinder head 5. Thus, said piston 1 and cylinder 2 form with the lower cylinder head 4 a lower hot gas chamber 6, and with the upper cylinder head 5 an upper hot gas chamber 7.

It is noted that cylinder 2 is attached to the transmission case 3 that houses the transmission means 8 to which the double-acting piston 1 is connected. Said means 8 are provided for transforming the back and forth movements carried out by the double-acting piston 1 in the cylinder 2, into the continuous rotary motion of a crankshaft 11. To this end, and still according to this non-limiting example, said means 8 consist of a rod 9 connected to the double-acting piston 1 by a butt 12, said rod 9 being hinged around a crank 10 fitted on the crankshaft 11.

It is noted that in the transfer-expansion and regenerative heat engine chosen here as an example of application, it is necessary to provide sealing means 40 similar to those described in the French patent application No. 1,550,762 and No. 1,551,593 and belonging to the applicant.

As such, and as shown in FIGS. 2 to 4, one can for example provide a perforated continuous ring 41 housed in a ring groove 39, mounting said ring 41 requiring that said groove 39 be assembled in two parts. For this first reason, and because it is otherwise extremely difficult to reduce the weight of the double-acting piston 1, FIGS. 2 to 4 show that the latter is assembled and consists of a lower half-piston 13 and an upper half-piston 14.

This configuration effectively allows providing a ring groove 39, itself assembled, which enables mounting the perforated continuous ring 41. In addition, said configuration allows providing a lower relief recess 25 in the lower half-piston 13 and an upper relief recess 26 in the upper half-piston 14.

It is noted that in order for the double-acting piston 1 of the invention to be as light as possible, it is imperative to seek its constituent material in the most rational way possible. It is for this reason that said piston consists of a prestressed assembly which—according to the exemplary non-limiting embodiment chosen here to illustrate the operation—provides that the lower piston cap 15 and the upper piston cap 16 each constitute two low thickness arches, respectively with the lower relief recess 25 and with the upper relief recess 26.

In order for an arch to be rigid, it is necessary that its two baseplates be securely anchored. This is a prerequisite so that said arch can retransmit the load to which it is subjected to said baseplates. Thus, as is clearly seen in FIG. 4, anchoring the first baseplate of the two arches formed by the lower piston cap 15 consists of the junction between said cap 15 and the lower central pillar 23 while anchoring the second baseplate of said two arches consists of the lower radial limit stop 35 which bears on the radial traction stop 34 included in the peripheral zone 33 of the radial traction disc 30. The same principle is adopted for the upper piston cap 16.

Let us recall here that the thickness and the geometry of the radial traction disc 30 as well as the axial position of the lower central clamping surface 19, of the upper central clamping surface 20, of the lower peripheral clamping surface 21, and the upper peripheral clamping surface 22 are provided so that when the clamping screw 29 is tightened while mounting the double-acting piston 1, said disc 30 is first compressed between the lower peripheral clamping surface 21 and the upper peripheral clamping surface 22 before being compressed between the lower central clamping surface 19 and the upper central clamping surface 20.

It does result from this arrangement that the lower piston cap 15 and the upper piston cap 16 are deformed and are placed under prestress which ensures, on the one hand, the clamping of the radial traction disc 30 at its peripheral zone 33 when the double-acting piston 1 is deformed under the effect of the pressure in the lower hot gas chamber 6 or in the upper hot gas chamber 7, and which ensures, on the other hand, that the lower radial limit stop 35 and the upper radial limit stop 36 each bear against the radial traction stop 34 with which they cooperate.

As seen in FIGS. 3 and 4, advantageously, the radial traction disc 30 consists of two radial traction half-discs 46 on the surface of which are arranged radial duct groves 47 which represent as many radial air supply ducts 45 when said two half-discs 46 are pressed against each other as a result of the tightening of the clamping screw 29. This configuration allows driving compressed air from the pressure chamber 49 up to the perforated continuous ring 41 which, according to this non-limiting example, forms the sealing means 40 between the double-acting piston 1 and the cylinder 2.

The clamping screw 29, seen in FIGS. 3 and 4, allows clamping the lower half-piston 13, the radial traction disc 30, and the upper half-piston 14 between them. Advantageously, this screw is made of high strength steel which must remain at a relatively low temperature not exceeding—for example—one hundred fifty or two hundred degrees Celsius.

To do this, we note that the clamping screw 29 is only in direct contact with parts kept at low temperature. For example, said screw 29 has a clamping screw head 67 which remains in contact with the end of the upper piston rod 18 which is always immersed in the pressure chamber 49 maintained at low temperature regardless of the position of the piston double-acting 1. Further, said screw 29 has a screw thread 68 screwed into the butt 12 which is also maintained at low temperature.

It is noted that the body of the clamping screw 29 is in contact neither with the inner wall of the lower clamping screw bore 27, nor with that of the upper clamping screw bore 28, nor with the screw through-hole 31. The air being a powerful thermal insulation, this arrangement limits drastically any heat transfer from the lower half-piston 13 and the upper half-piston 14 towards the body of the clamping screw 29.

In addition, cooling of the body of the clamping screw 29 by the air coming from the pressure chamber 49 and going to the perforated continuous ring 41 should be noted, said air passing through the screw cooling tube 53. Indeed, this air, maintained at a moderate temperature of the order of one hundred degrees or even less, enters said tube 53 through the air supply channels 48 that are included—according to the embodiment shown in FIGS. 2 to 4—in a perforated support disc 69 that surrounds the clamping screw head 67. Particularly in FIG. 4, it is noted that, after crossing said channels 48, said air enters—through the tube flange 55—into the space left between the screw cooling tube 53 and the outer surface of the clamping screw 29.

It should be noted—particularly in FIG. 4—that the screw cooling tube 53 comprises near the tube flange 55 a tube bulge 56 which ensures that said tube 53 remains locally centered in the upper clamping screw bore 28. It should further be noted that on either side of the screw through-hole 31, each of the two other tube bulges 56 forms both a centering and a sealing respectively between the screw cooling tube 53 and the upper clamping screw bore 28, and between said tube 53 and the lower clamping screw bore 27. Said other two bulges 56 cooperate with a tube diameter restriction 57 arranged in the vicinity of the lower end of the screw cooling tube 53, said restriction 57 locally creating a seal between said tube 53 and the body of the clamping screw 29.

The inset of FIG. 4 also shows the special configurations provided by the double-acting piston 1 according to the invention to protect the perforated continuous ring 41 from excessive temperature rise. As such, this inset shows the ring groove 39 formed by the two radial traction half-discs 46 when they are pressed against each other as a result of the tightening of the clamping screw 29.

It can be seen therein that the lower overhang 43 and the upper overhang 44 form together a groove of groove 42 which leaves an air gap between them and the radial traction disc 30 at the ring groove 39. Said blade constitutes a thermal barrier which limits the heat transfer from the lower half-piston 13 and the upper half-piston 14 towards the perforated continuous ring 41.

FIG. 5 shows the rod sealing means 59 which ensure sealing between the lower hot gas chamber 6 and the lower piston rod 17 while ensuring the lubrication of the upper rod seal 60 and the lower rod seal 61 which form said means 59. It is noted that said means 59 also ensure cooling of the lower piston rod 17 by means of an oil flow chamber 62 into which a cooling-lubricating oil supply duct 63 enters, and out of which a cooling-lubricating oil outlet duct 64 goes. It is easy to see that the oil flow that circulates between said ducts 63, 64 being permanently in contact with the lower piston rod 17, said flow rate enables maintaining said rod 17 at a temperature, for example, slightly greater than one hundred degrees Celsius, but not higher.

Still in reference to FIG. 5, It is noted that, advantageously, the upper rod seal 60 consists of two superposed cutting segments whose sections are angularly offset, while the lower rod seal 61 consists of a single cutting segment, both of these seals 60, 61 being held at a distance from each other by a segment retractor spring 65 which has holes allowing the cooling and lubricating oil flow to pass between the cooling-lubricating oil supply duct 63 and the cooling-lubricating oil outlet duct 64 through the oil flow chamber 62.

FIG. 6 shows the same arrangement with the main difference that the segment retractor spring 65 is replaced by a rod guiding ring 66 which ensures radial guidance of the upper piston rod 18 which, in the non-limiting example chosen here to illustrate the operation of the double-acting piston 1 according to the invention, opens into the pressure chamber 49 that supplies compressed air to the perforated continuous ring 41.

When the transfer-expansion and regenerative heat engine, chosen here as an example of application, stops, it is noted that the oil pump that supplies the oil flow chambers 62 continues to supply oil to the latter to cool the lower piston rod 17 and the upper piston rod 18 and this, as long as the lower cylinder head 4 and the upper cylinder head 5 continue to transmit heat to said chambers 62 and risk bringing the oil contained in said chambers 62 to coking temperature.

The possibilities of the double-acting piston 1 according to the invention are not limited to the applications that have just been described and it must also be understood that the above description has been given only as an example and that it does not limit the scope of said invention, and that replacing the details of execution described by any other equivalent would not be considered as being outside said scope.

1. A double-acting piston (1) operable at high temperature and cooperating with transmission means (8) to move in a cylinder (2) whose end which opens on the side of said means (8) is closed by a lower cylinder head (4) to define with said piston (1) a lower hot gas chamber (6), and whose other end is closed by an upper cylinder head (5) to define with said piston (1) an upper hot gas chamber(7), the transmission means (8) being accommodated in a transmission case (3) on which is fixed, directly or indirectly, the cylinder (2) characterized in that it comprises:
A lower half-piston (13) having a lower piston cap (15) facing the lower hot gas chamber (6), said cap (15) being prolonged by a lower piston rod (17) which passes through the lower cylinder head (4) via a lower rod orifice (37) provided in said cylinder head (4), said rod (17) being directly or indirectly integral with transmission means (8), while the face of said half-piston (13) opposite to said cap (15) is hollow and constitutes a lower relief recess (25);
A lower central pillar (23), coaxial with the lower half-piston (13) which is accommodated in the lower relief recess (25) to terminate by a lower central clamping surface (19);
At least one lower peripheral clamping surface (21) provided at the lower half-piston (13) and bordering the lower relief recess (25) at the periphery of said half-piston (13);
At least one lower radial limit stop (35) provided in the lower half-piston (13) near the lower peripheral clamping surface (21);
A lower clamping screw bore (27) provided in the lower half-piston (13) at its center, and which passes through said half-piston (13) from one side to the other in an axial direction;
An upper half-piston (14) having a upper piston cap (16) oriented opposite to the upper hot gas chamber (7), said cap (16) being prolonged or not by an upper piston rod (18) that penetrates or passes through the upper cylinder head (5) via an upper rod orifice (38) provided in said cylinder head (5), while the face of said half-piston (14) opposite to said cap (16) is hollow and constitutes an upper relief recess (26);
An upper central pillar (24), coaxial with the upper half-piston (14), which is accommodated in the upper relief recess (26) to end in an upper central clamping surface (20);
At least one upper peripheral clamping surface (22) arranged on the upper half-piston (14) and bordering the upper relief recess (26) at the periphery of said half-piston (14);
At least one upper radial limit stop (36) provided in the upper half-piston (14) near the upper peripheral clamping surface (22);
An upper clamping screw bore (28) provided in the top half-piston (14) at its center, and which passes through said half-piston (14) from one side to the other in an axial direction;
At least one radial traction disc (30), perforated or not, pierced at its center with a screw passage orifice (31) whose outer diameter is close to that of the double-acting piston (1), whose central zone (32) is tightly mounted between the lower central clamping surface (19) and the upper central clamping surface (20), whose peripheral zone (33) is tightly mounted between the lower peripheral clamping surface (21) and the upper peripheral clamping surface (22) and whose periphery comprises at least one radial traction stop (34) which can cooperate with the lower radial limit stop (35) and/or the upper radial limit stop (36);
A clamping screw (29) housed partly in the lower clamping screw bore (27) and partly in the upper clamping screw bore (28), the first end of said screw (29) being made integral with transmission means (8) while the second end of said screw (29) is made integral with the upper piston rod (18) or the upper piston cap (16).

2. The double-acting piston according to claim 1, characterized in that the thickness and the geometry of the radial traction disc (30) as well as the axial position of the lower central clamping surface (19), of the upper central clamping surface (20), of the lower peripheral clamping surface (21) and of the upper peripheral clamping surface (22) are provided so that when the clamping screw (29) is tightened while mounting the double-acting piston (1), said disc (30) is first compressed between the lower peripheral clamping surface (21) and the upper peripheral clamping surface (22) before being compressed between the lower central clamping surface (19) and the upper central clamping surface (20).

3. The double-acting piston according to claim 2, characterized in that the radial position of the radial traction stop (34) relative to that of the lower radial limit stop (35) and/or that of the upper radial limit stop (36) is provided so that when the clamping screw (29) is tightened while mounting the double-acting piston (1), said lower (35) and/or upper (36) radial limit stop comes in contact with the radial traction stop (34) and limits the diameter of the lower half-piston (13) and/or the upper half-piston (14).

4. The double-acting piston according to claim 1, characterized in that the radial traction disc (30) has at its periphery a ring groove (39) which can accommodate sealing means (40).

5. The double-acting piston according to claim 4, characterized in that the ring groove (39) is housed in a groove of groove (42) that is commonly constituted by a lower overhang (43) comprised by the lower half-piston lower (13) in its periphery, and an upper overhang (44) comprised by the upper half-piston (14) in its periphery.

6. The double-acting piston according to claim 1, characterized in that at least one air supply radial duct (45) is arranged in the thickness of the radial traction disc (30), said duct (45) connecting the screw through-hole (31) to the periphery of said disk (30).

7. The double-acting piston according to claim 6, characterized in that the radial traction disc (30) consists of two radial traction half-discs (46) on the surface of at least one of which is arranged at least one radial duct groove (47) which constitutes the air supply radial duct (45) when said two half-discs (46) are pressed against one another as a result to the clamping of the clamping screw (29).

8. The double-acting piston according to claim 1, characterized in that the end of the upper piston rod (18) which is furthest from the piston upper cap (16) is always immersed in a pressure chamber (49) filled with compressed air (54) whatever the position of the double-acting piston (1) in the cylinder (2), said chamber (49) being integral or not with the upper cylinder head (5) and being connected to a pressurized air source (50) from which compressed air (54) originates, while said end has at least one air supply channel (48) connecting the upper clamping screw bore (28) with the pressure chamber (49).

9. The double-acting piston according to claim 8, characterized in that the air supply channel (48) consists of a radial groove arranged either on the flat end of the upper piston rod (18) which is furthest from the upper piston cap (16) or on at least one side of a screw thrust washer on which the clamping screw (29) rests.

10. The double-acting piston according to claim 8, characterized in that a screw cooling tube (53) surrounds the clamping screw (29) on all or part of its length, compressed air (54) coming from the pressurized air source (50) being able to circulate in a space left between the inner wall of said tube (53) and the outer surface of the clamping screw (29) while the greatest possible part of the outer surface of said tube (23) does not touch the internal wall of the upper clamping screw bore (28) so as to define a vacuum space with the latter wall.

11. The double-acting piston according to claim 10, characterized in that the screw cooling tube (53) comprises a tube flange (55) held tightly by the clamping screw (29) against the end of the upper rod piston (18).

12. The double-acting piston according to claim 10, characterized in that the screw cooling tube (53) comprises at least a tube bulge (56) consisting of an axial portion of said tube (53) whose diameter is substantially equivalent or even slightly greater than that of the upper clamping screw bore (28) or the lower clamping screw bore (27) in which it is housed.

13. The double-acting piston according to claim 10, characterized in that the screw cooling tube (53) comprises at least one tube diameter restriction (57) consisting of an axial portion of said tube (53) whose diameter is substantially equivalent or even slightly lower than that of the body of the clamping screw (29).

14. The double-acting piston according to claim 10, characterized in that the screw cooling tube (53) has at least one radial communication hole (58) which allows the compressed air (54) to enter into said tube (53), or to escape from it.

15. The double-acting piston according to claim 1, characterized in that the lower rod orifice (37) and/or the upper rod orifice (38) cooperates with—or comprises—rod sealing means (59) creating a seal between the lower piston rod (17) and the lower cylinder head (4) and/or between the upper piston rod (18) and the upper cylinder head (5).

16. The double-acting piston according to claim 15, characterized in that the rod sealing means (59) comprise an upper rod seal (60) and a lower rod seal (61) sufficiently distant from one another to form—between said two seals (60, 61)—an oil flow chamber (62) into which a cooling-lubricating oil supply duct (63) enters, and out of which a cooling-lubricating oil outlet duct (64) goes.

17. The double-acting piston according to claim 16, characterized in that the rod sealing means (59) cooperate with a rod guiding ring (66) housed inside or outside the oil flow chamber (62).
